(19) United States
(12) Patent Application Publication
(10) Pub. No.: US 2015/0341857 A1
(43) Pub. Date: Nov. 26, 2015

(54) MOBILE STATION AND MOBILE COMMUNICATION METHOD

(71) Applicant: NTT DOCOMO, INC., Tokyo (JP)

(72) Inventors: Tooru Uchino, Tokyo (JP); Hideaki Takahashi, Tokyo (JP); Wuri Andarmawanti Hapsari, Tokyo (JP)

(73) Assignee: NTT DOCOMO, INC., Tokyo (JP)

(21) Appl. No.: 14/655,294

(22) PCT Filed: Dec. 25, 2013
(86) PCT No.: PCT/JP2013/084613

§ 371 Date: Jun. 24, 2015

(30) Foreign Application Priority Data
Dec. 28, 2012 (JP) 2012-288720

(51) Int. Cl. H04W 52/02; H04W 76/02; H04W 36/00

(52) U.S. Cl. CPC H04W 52/0216; H04W 36/0094; H04W 76/027

(57) ABSTRACT

The present invention achieves a DRX control appropriate from the view point of battery saving. A mobile station UE in the present invention includes a control unit 13 configured to detect RLF when downlink radio quality falls below a predetermined threshold value in all of a plurality of measurement target cells #1 to #6.

### TECHNICAL FIELD

The present invention relates to a mobile station and a mobile communication method.

### BACKGROUND ART

LTE (Long Term Evolution) and LTE-Advanced are specified such that control of causing a mobile station UE in an “RRC_Connected state” to transition to a DRX (Discontinuous Reception) state can be performed for battery saving of the mobile station UE.

Specifically, the mobile station UE in the DRX state is configured to transition between an Active state and an Inactive state.

The mobile station UE in the Active state is configured to monitor a PDCCH (Physical Downlink Control Channel) and report feedback information such as a CQI (Channel Quality Indicator), a PMI (Precoding Matrix Index), a RI (Rank Indicator), a PTI (Precoding Type Indicator), and the like to a radio base station eNB.

Meanwhile, the mobile station UE in the Inactive state is configured to be stopped from monitoring the PDCCH and reporting the feedback information to the radio base station eNB. Accordingly, battery saving of the mobile station UE can be achieved.

The mobile station UE is set to the Active state in any of the cases described below and is set to the Inactive state in cases other than those described below:
A case where any of “On duration timer”, “DRX-Inactivity Timer”, “DRX-Retransmission Timer”, and “MAC-Contention Resolution Timer” is active;
A case where a Scheduling Request is transmitted;
A case where “UL grant” for HARQ (Hybrid ARQ) retransmission in uplink is assigned; and
A case where no downlink control signal instructing new transmission is received through the PDCCH after reception of a Random Access Response.

Part (a) and (b) of FIG. 7 show operations of the mobile station UE set to transition to the DRX state.

Moreover, in LTE, the mobile station UE should always follow instructions from a network, i.e. should guarantee reception of downlink (DL) signals. Accordingly, it is specified that the mobile station UE monitors downlink signals (Radio Link Monitoring).

As shown in FIG. 8, it is specified such that the mobile station UE detects RLF (Radio Link Failure) when the mobile station UE cannot receive downlink signals for a predetermined period, and performs the following operation.

First, the mobile station UE starts a reconnection procedure to a best cell at this moment to guarantee that the mobile station UE can be controlled from the network.

Second, the mobile station UE autonomously stops transmission of all uplink (UL) signals to avoid interference with other cells and other mobile stations UE.

### PRIOR ART DOCUMENT

### Non-Patent Document

Non-patent document 1: 3GPP TS 36.321

### SUMMARY OF THE INVENTION

The mobile station UE in the DRX state starts the handover procedure and transitions to the Active state every time when the mobile station UE moves from one cell to another. This is not preferable from the view point of battery saving.

In view of this, a control is conceivable in which the mobile station UE in the DRX state is stopped from starting the handover procedure even when moving from one cell to another.

However, this control has a problem that, as shown in FIG. 9, the mobile station UE in the DRX state starts the reconnection procedure when moving from one cell to another, and eventually transitions to the Active state.

In this case, the mobile station UE needs to reestablish the radio link. Accordingly, this control is not preferable also from the view points of signaling load and delay related to communication restart.

The present invention has been made in view of the problems described above and an object thereof is to provide a mobile station and a mobile communication method which can achieve a DRX control appropriate from the viewpoint of battery saving.

A first feature of the present invention is summarized as a mobile station including a control unit configured to detect radio link failure when downlink radio quality falls below a predetermined threshold value in all of a plurality of measurement target cells.

A second feature of the present invention is summarized as a mobile communication method including the steps of: causing a mobile station in an intermittent reception state to start a random access procedure with a certain radio base station; and causing the certain radio base station to acquire context information on the mobile station from a radio base station managing any one of measurement target cells of the mobile station.

A third feature of the present invention is summarized as a mobile station including a transmission unit configured to notify a radio base station of the number of measurement target cells in which simultaneous monitoring of downlink signals is executable by the mobile station.

### BRIEF DESCRIPTION OF THE DRAWINGS

FIG. 1 is an overall configuration diagram of a mobile communication system in a first embodiment of the present invention.

FIG. 2 is a functional block diagram of a mobile station in the first embodiment of the present invention.

FIG. 3 is a functional block diagram of a radio base station in the first embodiment of the present invention.

FIG. 4 is a flowchart showing an operation of the mobile station in the first embodiment of the present invention.

FIG. 5 is an overall configuration diagram of a mobile communication system in a modified example 1 of the present invention.

FIG. 6 is a sequence diagram showing an operation of a mobile communication method in the modified example 1 of the present invention.

FIG. 7 is a view for explaining a conventional art.

FIG. 8 is a view for explaining a conventional art.

FIG. 9 is a view for explaining a conventional art.

### DETAILED DESCRIPTION

(Mobile Communication System in First Embodiment of Present Invention)

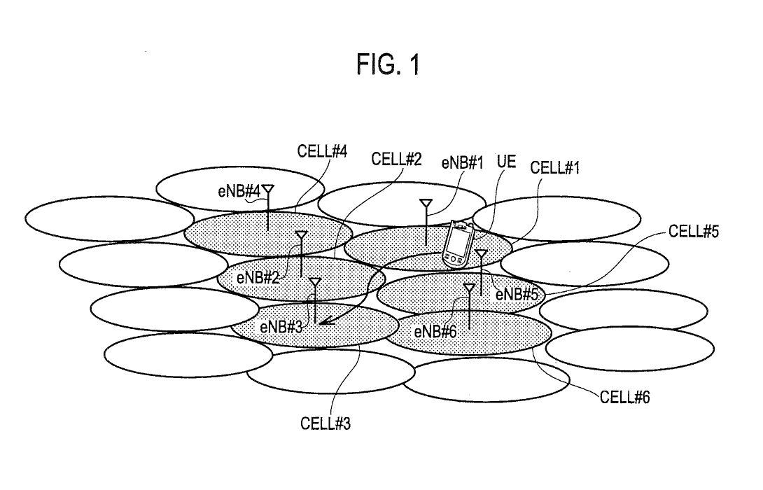

A mobile communication system in a first embodiment of the present invention is described with reference to FIGS. 1 to 4.

The mobile communication system in the embodiment is a LTE or LTE-Advanced mobile communication system and includes a radio base station eNB#6 and the like managing cells #1 to #6.

In the mobile communication system of the embodiment, a mobile station UE is assumed to be in an “RRC Connected state” in the cell #1 under a radio base station eNB#1. Moreover, in the mobile communication system in the embodiment, the mobile station UE is assumed to be in a DRX state.

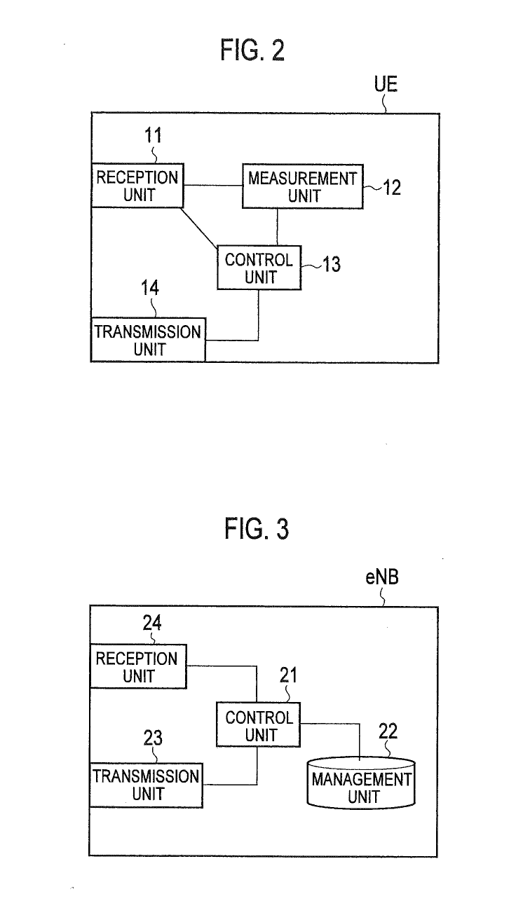

As shown in FIG. 2, the mobile station UE in the embodiment includes a reception unit 11, a measurement unit 12, a control unit 13, and a transmission unit 14.

The reception unit 11 is configured to receive various signals from the radio base station eNB#1.

Specifically, the reception unit 11 is configured to receive downlink signals from the radio base station eNB#1 through a PDSCH (Physical Downlink Shared Channel), a PDCCH (Physical Downlink Control Channel), a PCH (Paging Channel), a BCH (Broadcast Channel), and the like.

For example, the reception unit 11 is configured to acquire information indicating multiple measurement target cells #1 to #6 such as “RRC Connection Configuration”, “RRC Connection Reconfiguration”, and the like.

The measurement unit 12 is configured to measure the downlink radio quality in the aforementioned measurement target cells #1 to #6.

The control unit 13 is configured to perform various controls in the mobile station UE such as a control related to DRX, a control related to RLM, a control related to handover, and the like.

For example, the control unit 13 may be configured to detect RLF when the downlink radio quality falls below a predetermined threshold value in all of the multiple measurement target cells #1 to #6.

The aforementioned threshold value maybe common for the cells #1 to #6 or may vary among the respective cells.

The control unit 13 may be configured to detect the RLF only when the downlink radio quality falls below the predetermined threshold value in all of the multiple measurement target cells #1 to #6 while the mobile station UE is in a DRX state.

The measurement unit 12 may be configured to measure the downlink radio quality in all of the measurement target cells #1 to #6 in “On duration” or may be configured to measure the downlink radio quality in some of the measurement target cells #1 to #6 in “On duration”.

Moreover, the control unit 13 may be configured to detect the RLF when the downlink radio quality falls below the predetermined threshold value in a predetermined number of cells among the multiple measurement target cells #1 to #6.

Moreover, the transmission unit 14 is configured to transmit various signals to the radio base station eNB#1.

Specifically, the transmission unit 14 is configured to transmit uplink signals to the radio base station eNB#1 through a PUSCH (Physical Uplink Shared Channel), a PUCCH (Physical Uplink Control Channel), a RACH (Random Access Channel), and the like.

For example, the transmission unit 14 is configured to transmit a “Measurement Report” to the radio base station eNB#1.

Since configurations of the radio base stations eNB#1 to eNB#6 are basically the same, the configurations are described below as a configuration of a radio base station eNB. As shown in FIG. 3, the radio base station eNB in the embodiment includes a control unit 21, a management unit 22, a transmission unit 23, and a reception unit 24.

The control unit 21 is configured to perform various controls in the radio base station eNB such as a control related to DRX, a control related to handover, and the like.

For example, the control unit 21 is configured not to start handover of the mobile station UE to the measurement target cells #2 to #6 even when the mobile station UE transmits the “Measurement Report” for the measurement target cells #2 to #6.

The management unit 22 is configured to manage various types of information on the mobile station UE in the “RRC Connected state” in the cell under the radio base station eNB such as the measurement target cells #1 to #6.

The transmission unit 23 is configured to transmit various signals to the mobile station UE, other radio base stations eNB, and an upper node. The reception unit 24 is configured to receive various signals from the mobile station UE, the other radio base stations eNB, the upper node, and the like.

Specifically, the transmission unit 23 is configured to transmit downlink signals to the mobile station UE via the PDSCH, the PDCCH, the PCH, the BCH, and the like.

For example, the transmission unit 23 may be configured to notify the mobile station UE of the aforementioned measurement target cells #1 to #6 by using the “RRC Connection Configuration” and the “RRC Connection Reconfiguration”.

Note that the radio base station eNB may be configured to determine cells to be set as the measurement target cells depending on synchronization states with the other radio base stations eNB.

For example, the radio base station eNB may be configured to set cells under other radio base stations eNB synchronized with the radio base station eNB at a certain level, as the measurement target cells.

Moreover, the reception unit 24 is configured to receive the uplink signals from the mobile station UE through the PUSCH, the PUCCH, the RACH (Random Access Channel), and the like.

For example, the reception unit 24 may be configured to receive the “Measurement Report” from the mobile station UE.

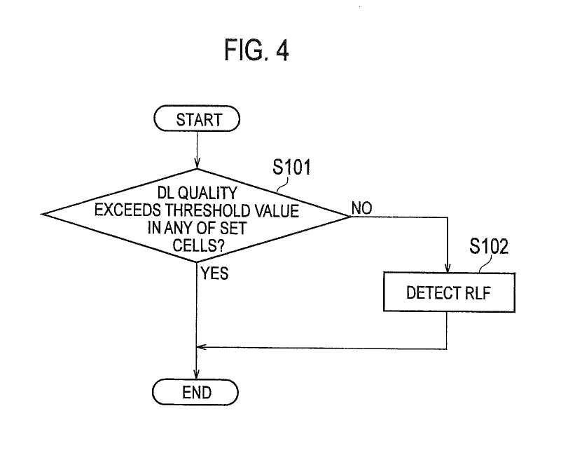

An operation of the mobile communication system in the embodiment, specifically an operation of the mobile station in the embodiment is described below with reference to FIG. 4.

As shown in FIG. 4, in step S101, the mobile station UE determines whether the downlink radio quality exceeds the predetermined threshold value in any of the measurement target cells #1 to #6.

If “YES”, the operation is terminated. If “NO”, the operation proceeds to step S102.

In step S102, the mobile station UE detects the RLF.

### Modified Example 1

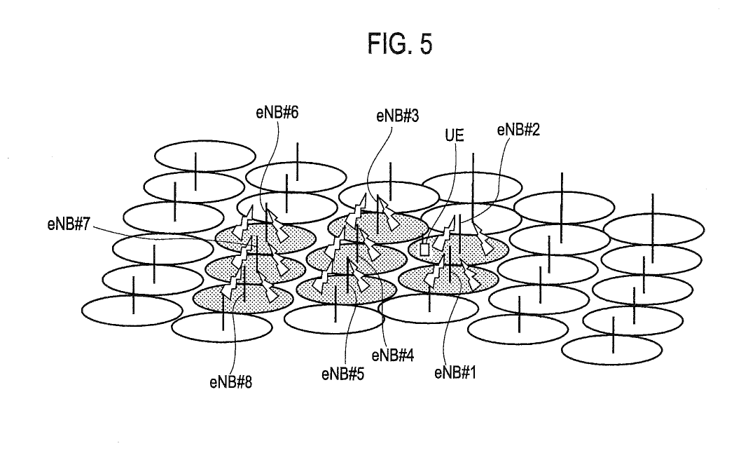

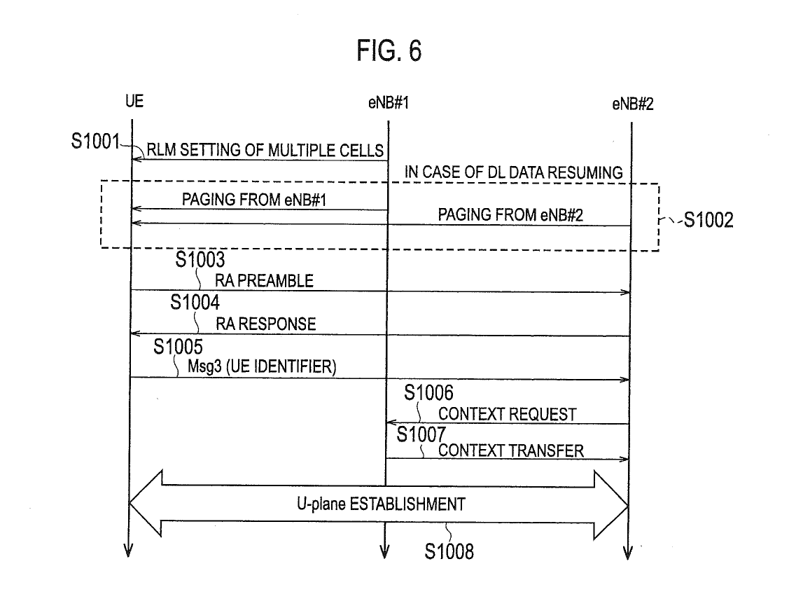

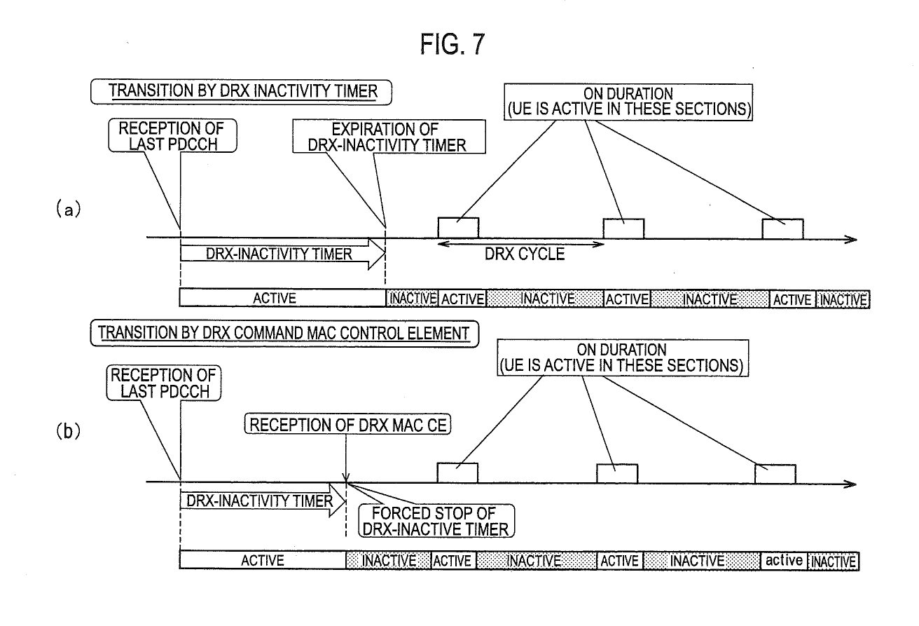

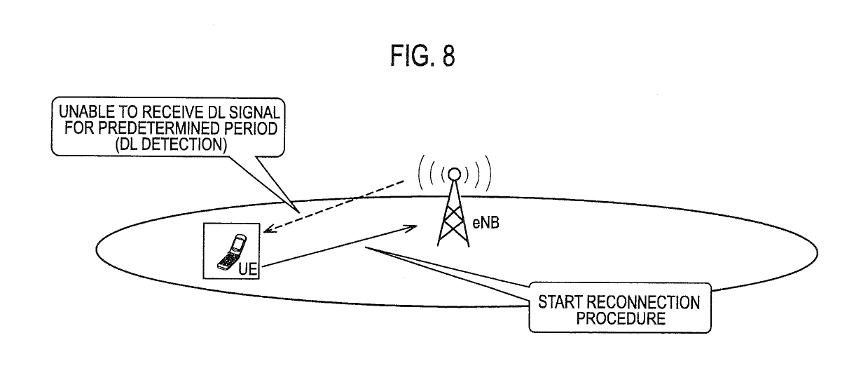

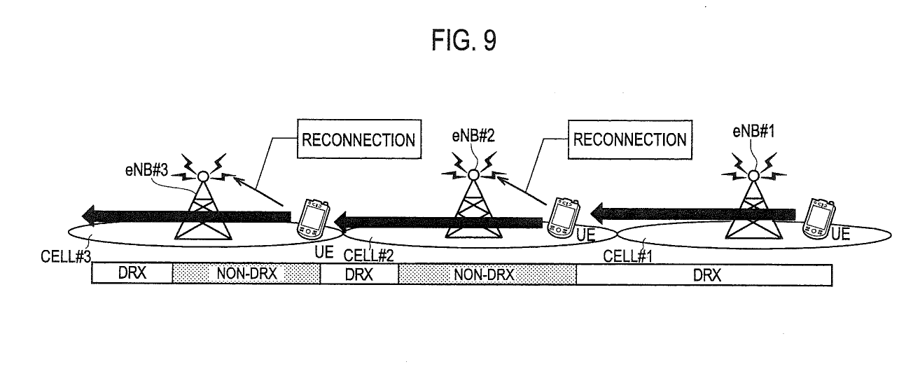

A mobile communication system in a modified example 1 of the present invention is described below with reference to FIGS. 5 and 6, focusing on differences from the aforementioned mobile communication system in the first embodiment.

As shown in FIG. 5, the mobile communication system in the modified example 1 is a LTE or LTE-Advanced mobile communication system and includes a radio base station eNB#8 and the like managing cells #1 to #8.

In the mobile communication system in the modified example 1, the mobile station UE is assumed to be in the “RRC Connected state” in the cell #1 under the radio base station eNB#1. Moreover, in the mobile communication system in the modified example 1, the mobile station UE is assumed to be in the DRX state. Furthermore, in the mobile communication system in the modified example 1, the mobile station UE is assumed to exist in a coverage area of the cell #2.

The operation of the mobile communication system in the modified example 1 is described below with reference to FIG. 6. Specifically, description is given of an operation performed when the mobile station UE recovers from the DRX state in the mobile communication system of the modified example.

As shown in FIG. 6, in step S1001, the radio base station eNB#1 notifies the mobile station UE of the measurement target cells #1 to #6.

When “DL data resuming” is performed, in step S1002, the radio base stations eNB#1 to eNB#6 managing the measurement target cells #1 to #6 transmit Paging to the mobile station UE to cause the mobile station UE to start a RA procedure.

In step S1003, the mobile station UE transmits a “RA preamble” to the radio base station eNB#2 in response to the Paging. In step S1004, the radio base station eNB#2 transmits a “RA response” to the mobile station UE.

In step S1005, the mobile station UE transmits Msg3 to the radio base station eNB#2, the Msg3 including an identifier of the mobile station UE such as IMSI (International Mobile Subscriber Identity), TMSI (Temporary Mobile Subscriber Identity), C-RNTI (Cell-Radio Network Temporary Identifier), and the like.

The radio base station eNB#2 determines the mobile station UE according to the transmitted Msg3. In step S1006, the radio base station eNB#2 transmits a “context request” requesting a “UE context” of the mobile station UE to the radio base station eNB#1 and the radio base stations eNB#3 to eNB#6. In step S1007, the radio base station eNB#2 acquires the “UE context” of the mobile station UE from the radio base station eNB#1.

In step S1008, a U-plane is established between the mobile station UE and the radio base station eNB#2.

Note that, when “UL data resuming” is performed, the aforementioned operation of step S1002 is omitted.

### Modified Example 2

A mobile communication system in a modified example 2 of the present invention is described below, focusing on differences from the aforementioned mobile communication system in the first embodiment.

In the mobile communication system of the modified example 2, the transmission unit 14 of the mobile station UE is configured to notify the radio base station eNB#1 of the number of measurement target cells in which simultaneous monitoring of downlink signals is executable by the mobile station UE.

Moreover, the transmission unit 14 of the mobile station UE may be configured to make such notification for each of duplex modes such as FDD (Frequency Division Duplex) and TDD (Time Division Duplex).

The transmission unit 14 may be configured to notify the radio base station eNB#1 of the aforementioned number of measurement target cells for each frequency band.

Alternatively, the transmission unit 14 may be configured to notify the radio base station eNB#1 of the aforementioned number of measurement target cells for each radio functional block (for example, RF).

The features of the present embodiment may also be expressed as follows.

A first feature of the present embodiment is summarized as a mobile station UE including a control unit 13 configured to detect RLF (radio link failure) when downlink radio quality falls below a predetermined threshold value in all of a plurality of measurement target cells #1 to #6.

In such a configuration, the mobile station UE in the DRX state starts no handover procedure or reconnection procedure even when moving from one cell to another, as long as the mobile station UE is in the coverage areas of the measurement target cells #1 to #6. Accordingly, effective battery saving can be achieved.

Moreover, in such a configuration, the mobile station UE in the DRX state can avoid unnecessary reestablishment of a radio link when moving from one cell to another, as long as the mobile station UE is in the coverage areas of the measurement target cells #1 to #6.

In the first feature of the present embodiment, the mobile station UE may be notified of the measurement target cells #1 to #6 by a radio base station eNB#1.

In such a configuration, a carrier (operator) can appropriately set the measurement target cells inconsideration of a communication environment, operator policies, and the like.

In the first feature of the present embodiment, the predetermined threshold value may vary among the cells.

In such a configuration, the carrier can appropriately set the aforementioned predetermined threshold value in consideration of a communication environment in each of the cells, the operator policies, and the like.

In the first feature of the present embodiment, the control unit 13 may detect the RLF, only when the downlink radio quality falls below the predetermined threshold value in all of the plurality of measurement target cells #1 to #6 while the mobile station UE is in a DRX state (intermittent reception state).

In such a configuration, such a control is performed only for the mobile station UE in the DRX state. This can minimize impacts on cell planning, operations, and the like by the carrier.

A second feature of the present embodiment is summarized as a mobile communication method including the steps of: causing a mobile station UE in a DRX state to start a random access procedure with a radio base station eNB#2; and causing the radio base station eNB#2 to acquire a “UE context (context information)” on the mobile station UE from a radio base station eNB#1 managing a measurement target cell #1 of the mobile station UE.

In such a configuration, the U-plane can be established between the radio base station eNB#2 and the mobile station UE even when the radio base station eNB#2 does not know in which cell the mobile station UE exists.

In the second feature of the present embodiment, the mobile communication method further may include the step of causing the radio base station eNB#2 to transmit a “Paging (paging signal)” in all of the measurement target cells #1 to #8 of the mobile station UE to cause the mobile station UE to start the random access procedure.

In such a configuration, the “DL data resuming” can be appropriately achieved.

A third feature of the present embodiment is summarized as a mobile station UE including a transmission unit 14 configured to notify a radio base station eNB of the number of measurement target cells in which simultaneous monitoring of downlink signals is executable by the mobile station UE.

In such a configuration, the radio base station eNB can set the appropriate number of measurement target cells for each mobile station UE.

In the third feature of the present embodiment, the transmission unit 14 may notify the radio base station eNB of the number of measurement target cells for each frequency band.

In the third feature of the present embodiment, the transmission unit 14 may notify the number of measurement target cells for each radio functional blocks.

In such configurations, the radio base station eNB can flexibly set the measurement target cells in consideration of states of the frequency bands and the radio functional blocks.

It should be noted that the foregoing operations of the mobile station UE and the radio base stations eNB#1 to eNB#8 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE and the radio base stations eNB#1 to eNB#8. Otherwise, the storage medium and the processor may be provided as discrete components inside the mobile station UE and the radio base stations eNB#1 to eNB#8.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2012-288720 (filed on Dec. 28, 2012) is incorporated by reference in the present specification.

### INDUSTRIAL APPLICABILITY

As described above, the present invention can provide a mobile station and a mobile communication method which can achieve a DRX control appropriate from the viewpoint of battery saving.

### EXPLANATION OF THE REFERENCE NUMERALS

eNB radio base station

UE mobile station

11, 24 reception unit

12 measurement unit

13, 21 control unit

14, 23 transmission unit

22 management unit

1. A mobile station comprising a control unit configured to detect radio link failure when downlink radio quality falls below a predetermined threshold value in all of a plurality of measurement target cells.

2. The mobile station according to claim 1, wherein the mobile station is notified of the measurement target cells by a radio base station.

3. The mobile station according to claim 1, wherein the predetermined threshold value varies among the cells.

4. The mobile station according to claim 1, wherein the control unit detects the radio link failure, only when the downlink radio quality falls below the predetermined threshold value in all of the plurality of measurement target cells while the mobile station is in an intermittent reception state.

5. A mobile communication method comprising the steps of:
causing a mobile station in an intermittent reception state to start a random access procedure with a certain radio base station; and
causing the certain radio base station to acquire context information on the mobile station from a radio base station managing any one of measurement target cells of the mobile station.

6. The mobile communication method according to claim 5, further comprising the step of causing the certain radio base station to transmit a paging signal in all of the measurement target cells of the mobile station to cause the mobile station to start the random access procedure.

7. A mobile station comprising a transmission unit configured to notify a radio base station of the number of measurement target cells in which simultaneous monitoring of downlink signals is executable by the mobile station.

8. The mobile station according to claim 7, wherein the transmission unit notifies the radio base station of the number of measurement target cells for each frequency band.

9. The mobile station according to claim 7, wherein the transmission unit notifies the number of measurement target cells for each radio functional blocks.

10. The mobile station according to claim 2, wherein the predetermined threshold value varies among the cells.
